(19) United States
(12) Patent Application Publication
(10) Pub. No.: US 2024/0416622 A1
(43) Pub. Date: Dec. 19, 2024

(54) HIGH BARRIER, PVC FREE, COLD FORMING MULTILAYER BLISTER LAMINATES

(71) Applicant: BILCARE LIMITED, Pune- Maharashtra (IN)

(72) Inventors: Shreyans Mohan BHANDARI, Pune- Maharashtra (IN); Sanjeev Dattatray KULKARNI, Pune- Maharashtra (IN); Mohan Harakchand BHANDARI, Pune- Maharashtra (IN); Somenath Sailen M MUKHERJEE, Pune- Maharashtra (IN)

(21) Appl. No.: 18/704,974

(22) PCT Filed: Jan. 13, 2022
(86) PCT No.: PCT/IB2022/050249

§ 371 Date: Apr. 26, 2024

(30) Foreign Application Priority Data
Oct. 29, 2021 (IN) 202121049694

(51) Int. Cl. B32B 15/088; B32B 7/12; B32B 15/085; B32B 15/20

(52) U.S. Cl. CPC B32B 15/088; B32B 7/12; B32B 15/085; B32B 15/20; B32B 2250/03; B32B 2255/10; B32B 2255/205; B32B 2307/40; B32B 2307/514; B32B 2307/7246; B32B 2307/7376; B32B 2311/24; B32B 2323/04; B32B 2377/00; B32B 2439/40

(57) ABSTRACT

The present disclosure relates to high barrier, polyvinyl chloride (PVC) free, cold forming multilayer blisters. The laminate comprises an intermediate aluminum layer, defining an operative outer surface and an operative inner surface; at least one polyethylene polymer layer adhered to the inner surface of the intermediate layer and an oriented polyamide layer, metallized on its operative outer surface, and adhered to the operative outer surface of the intermediate layer. The MULTILAYER laminate of the present disclosure has a water vapour transmission rate (WVTR) less than 0.0035 gm/pkg/day. The multilayer laminate of the present disclosure provides a high barrier against moisture, light and gas, which enhances the overall shelf life of the product that is being packaged.

This application is a patent of addition, filed under Section 54 of the Indian Patents Act, 1970, to the Indian patent application No. 201721038732 filed dated Oct. 31, 2017, the entire contents of which is specifically incorporated herein by reference.

### FIELD

The present disclosure relates to a pharmaceutical packaging. In particular, the present disclosure relates to a high barrier polyvinyl chloride (PVC) free cold forming multilayer blister laminates.

### Definitions

As used in the present disclosure, the following terms are generally intended to have the meaning as set forth below, except to the extent that the context in which they are used indicate otherwise.

The term “cold forming process” refers to stamping of the solid material to force it into a form, for shaping solid material into a desired shape and size, at or near room temperature. In case of blister packaging, it is achieved by application of force on a multilayer laminate in perpendicular direction to its parting line. The laminate stretches and retains the shape after the stamp has been removed.

The term “blister pack” refers to a formable web/multilayer laminate into which blisters or cavities are formed to pack the product, and a lid or a sealing layer, which is employed as a seal/cover/support. The product is placed within the blisters or cavities. It is a pre-formed plastic packaging used for small consumer goods, foods, and for pharmaceuticals.

The terms “blister cups” or “blisters” or “cavities” refer to a recess or a pocket in a laminate made by thermoforming or cold forming process to accommodate a product.

The terms “heat seal lacquer” or “HSL” refers to a coating that is applied on lid substrate that seals or adheres to a sealing layer of the blister under pressure and at specific temperature.

The term “sealing layer” is applicable for HSL that is coated on the operative inner surface of the lid material, i.e. a surface which is adjacent to the inner layer of the blister cups.

The term “support” or “base” refers to a layer of a film made up of aluminum foil or a polymer, covering/protecting the blister pockets or cavities. The term “base” also refers to the plane surface of the laminate sheet from where the stretching takes place to form the cavity or a recess. A recess is thus formed within the laminate, and with a shoulder defining the base material in between the recesses; the recesses of the base are filled with the products; and the base, with the filled recesses, is then covered with a lid, wherein the lid is sealed or otherwise adhered to the shoulder of the base. The lid material provides the base or structural component upon which the final blister package is built. Lid material is made of a paper or a polymer or an aluminum laminate is often called peel off-push through foil.

The term “oriented polyamide” refers to an alignment or a position of a polyamide polymeric film in a specified direction along the axis relative to the direction of stretching.

The term “metallized polyamide” refers to a vacuum metallization of aluminum in the presence of plasma on the oriented polyamide polymeric film.

The term “parting line” refers to a plane in which the two halves of a mold set to meet in which all features should be oriented perpendicular to the parting line to facilitate removal from the mold.

The term “draft” refers to an amount of taper provided for molded or cast parts perpendicular to the parting line.

The term “draft angle” refers to a draft provided to an article or sheet which is measured in degrees.

The term “normal” refers to a direction perpendicular to the plane of a given surface or object.

The terms “Water Vapour Transmission Rate” or “WVTR” refers to a steady state rate at which water vapour permeates through a film at specified conditions of temperature and relative humidity.

The term “Optical Density” refers to a degree at which an object or material reduces the intensity of light passing through it.

The term “barrier” refers to a property of blister laminates of separating a packed product such as an article of food or an electronic component, from an environment. Barrier properties include permeability of gases (such as O₂, CO₂, and N₂), water vapour, aroma compounds and light. These are vital factors for maintaining the quality of packaged products.

The term “capsule” refers to a solid pharmaceutical dosage form, in which the drug or a mixture of drugs is enclosed in a gelation shell or any other suitable material to form various shapes.

The terms “0” sized capsule or size “0” capsule refers to a capsule having a theoretical volume of 0.68 ml.

The term “doctoring technique” refers to a system of principles taught and/or advocated for manufacturing a product/commodity.

The term “blown” refers to polymer blown films, sometimes referred to as “tubular films”, and are manufactured by extruding molten resin vertically through a circular die. Air is introduced through the center of the die creating a bubble. The air drives the bubble upward, and slowly cools the material. Nip rollers flatten the material into a tube that can be reeled for creating bags and pouches, or slit and then reeled as a flat sheet of film.

The terms “downward blown” or “inverted blown” refers to polymer blown films manufactured by a process, wherein the extruders are located on the top of the tower, and the bubble is blown upside down.

The term “cast” or “cast films” refers to polymer films made by extruding melted resin horizontally through a flat die to create a sheet of material that is pinned to a highly polished chilled roller by means of an air curtain or vacuum box.

The term “shellac” refers to a resinous product obtained from the secretion of the female “lac bug” (Kerria lacca). It is processed and sold as dry flakes and dissolved in alcohol to make liquid shellac, which is used for coating.

### BACKGROUND

The background information herein below relates to the present disclosure but is not necessarily prior art.

Blister packages are employed for packaging numerous products including, but not limited to, consumer goods, foods, and pharmaceutical products. These blister packages protect the sealed product from external factors such as humidity, light, contamination and any other factors which may affect the quality of the sealed packed product.

The blister pack comprises a formable web/multilayer laminate into which blisters or cavities are formed, and a lid or a sealing layer or a support, which is employed as a seal, the product being placed within the blisters or cavities. Generally, the blisters or blister cups or cavities are formed by a cold forming process. Typically, a blister (also known as a “blister cup”) is a cavity structure formed on a multilayer laminate by the action of force acting on the multilayer laminate. A die is used for forming the blister cups or cavities on the multilayer laminate.

Typically, the multilayer laminate can comprise a first metallized layer, a metal layer, and a structural strengthening layer which can be a second polymer layer. The first polymer layer can be polyvinyl chloride (PVC), the metal employed can be aluminum and the structural strengthening layer can comprise a polymer such as a polyamide polymer component (the second polymer). The product placed within the blister is in contact with the inner layer of the multilayer laminate which is generally the PVC layer.

Typically, the metal used is in the form of a sheet/layer/layer which is stacked between the first polymer and the structural strengthening layer (which can be a second polymer). This metal layer provides structural stability, protection from the environmental factors and other factors. Further, the structural strengthening layer (as the name implies) provides the required mechanical properties. The first polymer layer along with the structural strengthening layer/second polymer (which can be a polyamide polymer) prevents the ingress of moisture into the package.

In the multilayer laminate comprising PVC as the inner layer (that is in contact with the product such as pharmaceutical tablets), the intermediate layer which can be an aluminum layer, and the structural strengthening layer (polyamide polymer) as the outer layer, it is observed that the draft angle (referred to as angle φ) that can be achieved is in the range of 30° to 75°. The blister cups having a larger draft angle needs to be spaced apart in the blister pack and hence results in a blister pack with larger size and/or volume, which is not desired.

Further, the disadvantages of using PVC layers include poor barrier against moisture ingress and oxygen ingress. Typical values for the Water Vapor Transmission Rate of a 250μ PVC film are around 3.0 g/m²/day to 3.2 g/m²/day measured at 38° C./90% RH. The PVC production poses serious environmental issues and health threats due to the manufacture of raw chemicals, including chlorine and cancer-causing vinyl chloride monomer. Moreover, harmful by-products are created as a result of the chemical composition of PVC, during both the creation and decomposition of the product.

There is, therefore, felt a need to provide a multilayer cold forming blister laminates which are devoid of PVC, that provides high barrier against water vapour and compact size and/or volume blisters can be formed from the laminates without affecting the barrier properties.

### Objects

Some of the objects of the present disclosure, which at least one embodiment herein satisfies, are as follows:

It is an object of the present disclosure to ameliorate one or more problems of prior art or to at least provide a useful alternative.

An object of the present disclosure is to provide a high barrier, multilayer, polyvinyl chloride (PVC) free, cold forming multilayer blister laminate and a process for its preparation.

Another object of the present disclosure is to provide a high barrier, multilayer, polyvinyl chloride (PVC) free, cold forming multilayer blister laminate with WVTR less than 0.0035 gm/pkg/day.

Yet another object of the present disclosure is to provide a high barrier, multilayer, polyvinyl chloride (PVC) free, cold forming multilayer blister laminate which provides high barrier to light and gas.

Yet another object of the present disclosure is to provide a high barrier, multilayer, polyvinyl chloride (PVC) free, cold forming multilayer blister laminate which make it compact so material consumption will reduce.

Still another object of the present disclosure is to provide a high barrier, multilayer, polyvinyl chloride (PVC) free, cold forming multilayer blister laminate which enhances the overall the shelf life of the product that is packaged.

Other objects and advantages of the present disclosure will be more apparent from the following description, which is not intended to limit the scope of the present disclosure.

### SUMMARY

In accordance with an aspect of the present disclosure, a high barrier, multilayer polyvinyl chloride (PVC) free, cold forming multilayer blister laminate is disclosed. The laminate comprises an intermediate aluminum layer having a thickness in the range of 20 microns to 60 microns, defining an operative outer surface and an operative inner surface; at least one polyethylene polymer layer, selected from high density polyethylene (HDPE), medium density polyethylene, low density polyethylene, linear polyethylene, cross-linked polyethylene, and ultra-high molecular weight polyethylene (UHMWPE), having a thickness in the range of 40 microns to 80 microns, adhered to the inner surface of the intermediate layer by means of an adhesive; and an oriented polyamide layer, metallized on its operative outer surface, the metallized oriented polyamide layer has an optical density in the range of 0.5 to 2.5, the metallized polyamide layer having a thickness in the range of 10 microns to 60 microns, and adhered to the operative outer surface of the intermediate layer by means of an adhesive. The laminate has a water vapour transmission rate (WVTR) of less than 0.0035 gm/pkg/day.

In accordance with another aspect of the present disclosure, a compact blister pack is disclosed. The compact blister pack comprises at least one blister shaped cup made up of a high barrier, multilayer polyvinyl chloride (PVC) free, cold forming multilayer blister laminate having an intermediate aluminum layer having thickness in the range of 20 microns to 60 microns, defining an operative outer surface and an operative inner surface; at least one polyethylene polymer layer, wherein the polyethylene is at least one selected from high density polyethylene (HDPE), medium density polyethylene, low density polyethylene, linear polyethylene, cross-linked polyethylene, and ultra-high molecular weight polyethylene (UHMWPE), having thickness in the range of 40 microns to 80 microns, adhered to the inner surface of the of the intermediate layer by means of an adhesive; an oriented polyamide layer, metallized on its operative outer surface, the oriented metallized polyamide layer has an optical density in the range of 0.5 to 2.5, the oriented metallized polyamide layer having thickness in the range of 10 microns to 60 microns, and adhered to the operative outer surface of the of the intermediate layer by means of an adhesive; and a lid defining an operative outer surface and an operative inner surface, wherein the operative inner surface is coated by using a heat seal lacquer in an amount in the range of 4 gsm to 10 gsm.

### BRIEF DESCRIPTION OF THE ACCOMPANYING DRAWING

The blister pack of the present disclosure will now be described with the help of the accompanying drawing, in which:

FIG. 1 illustrates the draft angle of the blister cups formed in a multilayer laminate of a conventional blister pack;

FIG. 2 illustrates the draft angle of the blister cups formed in a multilayer laminate of a blister pack in accordance with one embodiment of the present disclosure;

FIG. 3 illustrates the top view of the blister cup in accordance with one embodiment of the present disclosure; and

FIG. 4 illustrates a graph of the WVTR of blister package made in accordance with an embodiment of the present disclosure vs. the optical density of the laminate when cold formed into blisters adapted to accommodate a capsule of at least “0” size.

### LIST OF REFERENCE NUMERALS USED IN DETAILED DESCRIPTION AND DRAWING

100—blister pack in accordance with the prior art
102—blister cup
104—draft angle of the blister cup 102
200—blister pack in accordance with an embodiment of the present disclosure
202—blister cup
204—draft angle of the blister cup 202
300—blister pack in accordance with an embodiment of the present disclosure
302—first side wall
304—second side wall
306—third side wall
308—fourth side wall
310—lid

### DETAILED DESCRIPTION

Embodiments, of the present disclosure, will now be described with reference to the accompanying drawing.

Embodiments are provided so as to thoroughly and fully convey the scope of the present disclosure to the person skilled in the art. Numerous details are set forth, relating to specific components, and methods, to provide a complete understanding of embodiments of the present disclosure. It will be apparent to the person skilled in the art that the details provided in the embodiments should not be construed to limit the scope of the present disclosure. In some embodiments, well-known processes, well-known apparatus structures, and well-known techniques are not described in detail.

The terminology used, in the present disclosure, is only for the purpose of explaining a particular embodiment and such terminology shall not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, integers, steps, operations, elements, modules, units and/or components, but do not forbid the presence or addition of one or more other features, integers, steps, operations, elements, components, and/or groups thereof. The particular order of steps disclosed in the method and process of the present disclosure is not to be construed as necessarily requiring their performance as described or illustrated. It is also to be understood that additional or alternative steps may be employed.

The terms first, second, third, etc., should not be construed to limit the scope of the present disclosure as the aforementioned terms may be only used to distinguish one element, component, region, layer or section from another component, region, layer or section. Terms such as first, second, third etc., when used herein do not imply a specific sequence or order unless clearly suggested by the present disclosure.

The conventionally available blister packs are associated with the drawbacks such as the use of PVC layer, a low barrier against water vapours and a larger draft angle. These conventional blister cups having a larger draft angle needs to be spaced apart in the blister pack and hence results in the blister pack with larger size and/or volume, which is not desired.

The present disclosure relates to a high barrier, polyvinyl chloride (PVC) free, cold forming multilayer blister laminates, and blister packs made therefrom that overcomes the drawbacks of the conventional blister laminates.

In accordance with an aspect of the present disclosure, high barrier laminate devoid of polyvinyl chloride (PVC) for cold forming blisters are disclosed.

The high barrier multilayer laminate devoid of polyvinyl chloride (PVC) for cold forming blisters comprises an intermediate aluminum layer having a thickness in the range of 20 microns to 60 microns, defining an operative outer surface and an operative inner surface. At least one polyethylene polymer layer, selected from high density polyethylene (HDPE), medium density polyethylene, low density polyethylene, linear polyethylene, cross-linked polyethylene, chlorinated polyethylene and ultra-high molecular weight polyethylene (UHMWPE), having a thickness in the range of 40 microns to 80 microns, is adhered to the inner surface of the intermediate layer by means of an adhesive. An oriented polyamide layer, metallized on its operative outer surface, the metallized oriented polyamide layer has an optical density in the range of 0.5 to 2.5, and a thickness in the range of 10 microns to 60 microns, and is adhered to the operative outer surface of the intermediate layer by means of an adhesive. The laminate has a water vapour transmission rate (WVTR) of less than 0.0035 gm/pkg/day.

In accordance with an embodiment of the present disclosure, the polyethylene is made out of inverted blown process or cast process.

In accordance with the present disclosure, the intermediate aluminum layer offers a near complete barrier for moisture and oxygen. Further, as aluminum layer is fully opaque to light, the multilayer laminate provides good shielding against light. Typically, the thickness of the aluminum layer is in the range of 20 microns to 60 microns. In an exemplary embodiment, the thickness of the aluminum layer is 50 microns.

In accordance with an embodiment of the present disclosure, the polyethylene layer on the operative inner surface of the intermediate aluminum layer provides enhanced stretchability. In accordance with an exemplary embodiment of the present disclosure, the polyethylene polymer is at least one selected from the group consisting of high density polyethylene (HDPE), medium density polyethylene, low density polyethylene, linear polyethylene, cross-linked polyethylene, chlorinated polyethylene and ultra-high molecular weight polyethylene (UHMWPE). The propylene polymer layer on the operative inner surface of the intermediate aluminum layer with enhanced stretchability permits cold forming of the blisters in the multilayer laminate without rupturing. Typically, the thickness of the polyethylene polymer layer is in the range of 40 micron to 80 micron. In an exemplary embodiment, the thickness of the polyethylene layer is 40 microns. In another exemplary embodiment, the thickness of the polyethylene layer is 60 microns.

In accordance with an embodiment of the present disclosure, polyethylene is mixed with linear block copolymer based on styrene and butadiene with bound styrene of 29.5% mass to obtain modified polyethylene.

In accordance with an embodiment of the present disclosure, the polyethylene is made out of inverted blown process or cast process.

In accordance with the present disclosure, the layer adhered to the operative outer surface of the aluminum layer provides structural strength to the high barrier multilayer laminate which is devoid of polyvinyl chloride (PVC) for cold forming blisters and blister pack made therefrom.

In accordance with the present disclosure, the layer adhered to the operative outer surface of the aluminum layer is an oriented polyamide layer. The oriented polyamide layer is metallized on its operative outer surface to obtain a metallized oriented polyamide polymer (mOPA). The oriented metallized polyamide polymer is biaxially oriented. The biaxial orientation of metallized polyamide provides the structural strengthening property to the multilayer laminate. The metallized oriented polyamide provides high durability, high strength, abrasion resistance, resilience, and provides good balance between mechanical strength and barrier properties against oxygen, smell and oils. Typically, the thickness of the metallized oriented polyamide layer is in the range of 10 microns to 60 microns. In one embodiment, the metallized oriented polyamide polymer layer is 25 microns thick having metallization in the range of 0.5 to 3 optical density (OD), preferably in the range of 1.8 to 2.2 optical density (OD).

The inventors of the present disclosure have surprisingly found that increase in the metallization increases the optical density of the metallized layer. The inventors have also found that the optical density below 1.5 does not significantly contribute to the desired water vapour barrier. Further, if the optical density is higher than 2.4, then there are chances of flaking/cracking of metallized layer due to higher deposition of metal, and also not adding to enhancement in barrier property. In one embodiment, the metallized oriented polyamide layer is 25 micron thick having metallization in the range of 0.5 to 3 optical density (OD), preferably in the range of 1.8 to 2.2 optical density (OD).

Typically, an adhesive can be used between the layers to achieve adhesion there between. The adhesive used are acrylic based adhesive. Typically, the acrylic adhesive are at least one selected from acrylic adhesive, and ester acrylic adhesive.

In an embodiment, the thickness of the adhesive on the intermediate layer is in the range of 3 gsm to 6 gsm.

It is observed that the high barrier multilayer laminate devoid of polyvinyl chloride (PVC) for cold forming blisters of the present disclosure, described herein above, is characterized by having high stretchability as compared to the multilayer laminate with the polymer adhered to the inner surface of the aluminum layer being PVC.

In accordance with another aspect of the present disclosure, a compact blister pack comprising a high barrier laminate devoid of polyvinyl chloride (PVC) for cold forming blisters is disclosed.

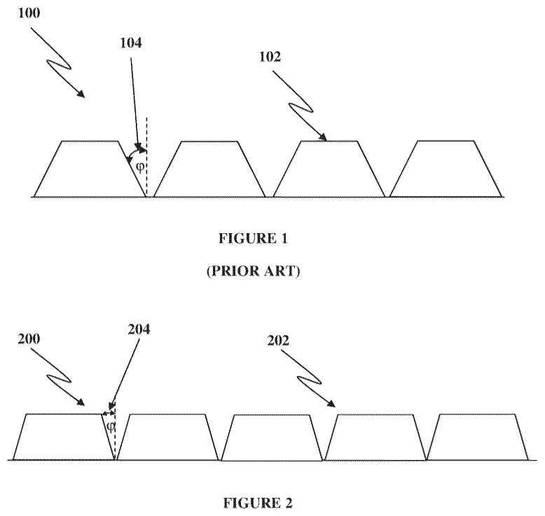

A blister pack (100), of the present disclosure will now be described with reference to FIG. 1 and FIG. 2. The preferred embodiment does not limit the scope and ambit of the present disclosure.

FIG. 1 illustrates angle φ 104 of blister cups 102 (cross sectional view) formed in a multilayer laminate of a conventional blister pack 100.

FIG. 2 illustrates angle φ 204 of the blister cups 202 (cross sectional view) formed in a multilayer laminate of a blister pack 200 in accordance with one embodiment of the present disclosure.

The compact blister pack of the present disclosure comprises a high barrier multilayer laminate devoid of polyvinyl chloride (PVC) with one or more blister cups formed thereon; and a sealing layer that covers the open ends of the blister cups formed on the multilayer laminate, wherein the draft angle of at least one of the blister cups is in the range of 15° to 30°, wherein the multilayer laminate comprises at least three layers, viz, an intermediate layer comprising an aluminum layer defining an operative outer surface and an operative inner surface, at least one polyethylene polymer layer adhered to the inner surface of the intermediate layer by means of an adhesive, and an oriented polyamide layer, metallized on its operative outer surface adhered to the operative outer surface of the intermediate layer by means of an adhesive.

The inventors of the present disclosure have surprisingly found that if the multilayer laminate has good stretchability, it is possible to form blister cups having angle φ starting from 15° (as seen in FIG. 2) as compared to the conventional multilayer laminates where angle φ could be in the range of 30° to 75° (as seen in FIG. 1) and could not be reduced below this range. It is evident from the FIGS. 1 and 2 that the size of the blister pack prepared by using the multilayer laminate of the present disclosure is small, wherein the angle φ of the blister cups is less as compared to that in the blister cups of the conventional blister pack. In other words, a relatively more number of blister cups can be formed by using the multilayer laminate of the present disclosure as compared to number of blister cups in the conventional blister pack of the same area. This result in reduction in the blister pack size as more number of blister cups are accommodated. The amount of multilayer laminate needed is also reduced as the area is reduced.

The compact blister pack, of the present disclosure, comprises blister shaped cups made of a high barrier multilayer laminate devoid of polyvinyl chloride (PVC) for cold forming blisters having: an intermediate aluminum layer defining an operative outer surface and an operative inner surface, at least one polyethylene layer adhered to the inner surface of the intermediate layer by means of an adhesive, and an oriented polyamide layer, metallized on its operative outer surface adhered to the operative outer surface of the intermediate layer by means of an adhesive; and a lid, defining an operative outer surface and an operative inner surface.

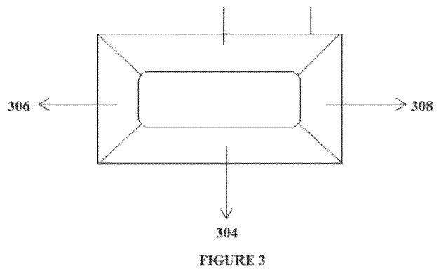

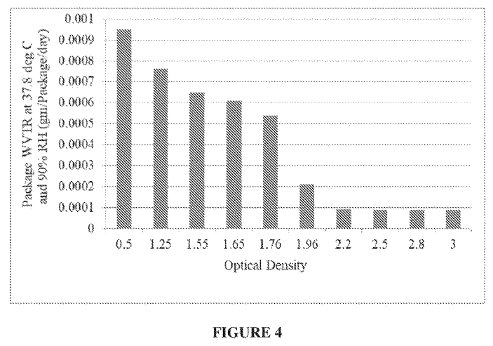

FIG. 3 illustrates a blister cup 300 defined by a first side wall 302 having a first edge and a second edge, the first side wall 302 extending in an operative upward direction from the lid 310 and slanted at an angle φ with respect to a normal to the lid 310. Further the blister cup 300 has a flat wall extending from a second edge of the first side wall 302, a second side wall 304 extending from a second edge of the flat wall in an operative downward direction abutting the lid 310 and slanted at an angle φ with respect to a normal to the lid 310, a third side wall 306 extending from a first lateral edge of the flat wall in an operative downward direction abutting the lid 310 and slanted at an angle φ with respect to a normal to the lid and a fourth side wall 308 extending from a second lateral edge of the flat wall in an operative downward direction abutting the lid 310 and slanted at an angle φ with respect to a normal to the lid 310.

In accordance with the present disclosure, the intermediate aluminum layer defines an operative outer surface and an operative inner surface. At least one polyethylene layer is adhered to the inner surface of the intermediate layer by means of an adhesive, and an oriented polyamide layer, metallized on its operative outer surface is adhered to the operative outer surface of the intermediate layer by means of an adhesive. It is found that use of the polyethylene leads to improvement in the stretchability of the multilayer laminate and the multilayer laminate does not break or rupture during the cold forming process even when angle φ is of less than 30° are attempted, typically in the range of 15° to 30°.

In accordance with another aspect of the present disclosure, a process for preparing a blister pack using the high barrier multilayer laminate devoid of polyvinyl chloride (PVC) for cold forming blisters of the present disclosure is provided.

The process comprises preparation of a metallized oriented polyamide polymer (mOPA). In an embodiment, the oriented metallized polyamide polymer is biaxially oriented. The process for metallization comprises application of aluminum via vacuum evaporation and layer growth. The process is performed in a vacuum evaporation deposition chamber. The pressure inside the chamber, during the process is maintained in the range of 1×10⁻³ mbar to 1×10⁻⁵ mbar. The temperature inside the chamber is maintained in the range of 813° C. to 900° C. Maintaining the vacuum inside the chamber avoids scattering of aluminum atoms and their reaction with other gas atoms and molecules. The aluminum is fed as a wire onto a resistance heated boat, from where it evaporates. The type of substrate as well as its orientation, evaporation temperature and rate play an important role. Further, coating thickness, angle of deposition and the energy of the condensed atoms or molecules also affect the material structure.

In an embodiment, the thickness of the aluminum deposition during the metallization process can be adjusted by the web speed of the layer.

In another embodiment, the evaporation rate is regulated by the energy input in the evaporator in combination with and/or the speed of aluminum feed. In an embodiment, the energy input is maintained in the range of 5.5 KHz to 8.5 KHz. As it is induction heating through high frequency to achieve the adequate temperature to evaporate aluminum.

The high barrier, polyvinyl chloride (PVC) free, cold forming multilayer blisters is fabricated by known process. Typically, the process involves stacking the polyethylene polymer layer, the aluminum layer and the metallized oriented polyamide layer and then passing them through a press roller. Typically, the process for fabricating the laminate of the present disclosure can be one of dry lamination and wet lamination process.

In dry lamination process, the substrate, which is a polyethylene polymer and/or aluminum layer and/or oriented polyamide, is brought in contact with gravure roller through a unwinder and then the gravure roller picks up the adhesive/lacquer from a tray and deposits it on the substrate. The various layers are stacked over the lacquered substrate. The doctoring technique is applied prior to deposition of the lacquer in order to ensure uniform deposition of the lacquer. The lacquered substrate stacked with other layers travels through a controlled heating tunnel with a predetermined passage length (which can be in the range of 5 meters to 10 meters) where it is dried. In accordance with an exemplary embodiment, the pressure that is applied on to the lacquered substrate stacked with other layers can be in the range of 5 kg to 8 kg. The temperature of the nip roller can be in the range of 65° C. to 75° C. and the oven temperature can be in the range of 140° C. to 180° C.

Typically, an adhesive can be used between the layers to achieve adhesion there between. The adhesive used are acrylic based adhesive. Typically, the acrylic adhesive are at least one selected from acrylic adhesive, and ester acrylic adhesive.

In an embodiment, the thickness of the adhesive on the intermediate layer is in the range of 3 gsm to 6 gsm.

Typically, in accordance with the present disclosure, the blister cups or cavities are formed by the cold forming process, wherein a die is used to stamp the multilayer laminate of the present disclosure to obtain a multilayer laminate with one or more blister cups formed thereon. The product can be placed in the blister cups and the open end of the blister cups can be typically sealed with the sealing layer.

In accordance with the present disclosure, the lid layer, preferably an aluminum foil comprises an operative outer surface and an operative inner surface. In an embodiment, the operative outer surface of the aluminum lid is treated so as to be compatible for atmospheric exposure and receptive to adhesion of conventional printing inks, adhesives, lacquers, plastic films and other adhesively applied coatings; while its operative inner surface of the aluminum lid i.e. a sealing layer is treated so as to be compatible with the inner polymeric layer of the blisters (a layer exposed to the packaged material).

In an embodiment, hard temper aluminum foil is mounted on the unwinder of a coating machine. The operative outer surface of the aluminum foil is coated with a protective layer, to prevent oxidation on exposure to environment. In an embodiment, the aluminum foil is treated with isopropyl alcohol (IPA) and a shellac coat is applied over the treated aluminum foil as a protective layer. In another embodiment, degreasing of the aluminum lid outer layer is performed and the shellac coat is applied over the degreased layer in an amount in the range of 0.5 gsm to 1 gsm to protect the operative outer surface from oxidation (protective layer). Once protective layer is applied, the aluminum lid travels through a heating zone, wherein the solvent in the shellac coating is evaporated and the formed film is then cured to obtain cured lid.

The cured lid is then passed through a second station, wherein the treatment of the operative inner surface of the lid is performed to attain a sealability of the lid to the blister laminates. In an embodiment, the sealability of the aluminium lid against the formable polymer materials of blister packages is usually achieved by coating the operative inner layer of the aluminium lid with a predetermined amount of heat seal lacquers.

In an embodiment, the predetermined amount of the coating of the heat seal lacquer is in the range of 4 gsm to 6 gsm.

In another embodiment, the operative inner surface of the cured aluminum lid is coated with heat sealing lacquer in an amount in the range of 1 gsm to 2 gsm. The coated aluminum lid then travels through a heat zone, wherein the solvent in the heat sealing lacquer coating is evaporated to form a first coating film. The lid with the first coating film is then passed to another coating station for a second coating in an amount in the range of 3 gsm to 4 gsm over the first coating layer. The coated lid then travels through the heated station, wherein the solvent is evaporated to obtain aluminum lid with a cured sealing layer.

In yet another embodiment, the operative inner surface of the cured aluminum lid is coated with heat sealing lacquer in an amount in the range of 4 gsm to 10 gsm.

The obtained aluminum lid with the treated surfaces is then wound and stored for final usage.

In an embodiment, the heat seal lacquer is selected from a solvent based lacquer or water based lacquer, preferably water based lacquer. In another embodiment, the heat seal lacquer is polyolefin water based material having a good barrier against moisture.

In an embodiment, the aluminum lid having protective layer on its operative outer surface and heat seal lacquer sealing layer on its operative inner surface provides additional barrier against water vapour.

In an exemplary embodiment, the water vapour transmission rate (WVTR) of the laminate is in the range of 0.00095 gm/pkg/day to 0.000087 gm/pkg/day, wherein the water vapour transmission rate (WVTR) is measured for cold formed blisters adapted to accommodate capsules of at least “0” size.

In another exemplary embodiment, the intermediate aluminum layer has a thickness of 45 microns, the metallized oriented polyamide film has a thickness of 25 microns and optical density of 1.25, and the polyethylene layer has a thickness of 50 microns, wherein the laminate when cold formed into blisters, has a WVTR of 0.00076 gm/pkg/day at 37.8 deg. C. and 90% RH, when measured in accordance with ASTM F1249 standard, that is adapted to accommodate capsules of at least “0” size.

In still another exemplary embodiment, the intermediate aluminum layer has a thickness of 45 microns, the metallized oriented polyamide film has a thickness of 25 microns and optical density of 2.2, and the polyethylene layer has a thickness of 50 microns, wherein the laminate when cold formed into blisters, has a WVTR of 0.00009 gm/pkg/day at 37.8 deg. C. and 90% RH, when measured in accordance with ASTM F1249 standard, that is adapted to accommodate capsules of at least “0” size.

In yet another exemplary embodiment, the intermediate aluminum layer has a thickness of 45 microns, the metallized oriented polyamide film has a thickness of 25 microns and optical density of 1.55, and the polyethylene layer has a thickness of 45 microns, wherein the laminate when cold formed into blisters, has a WVTR of 0.00065 gm/pkg/day at 37.8 deg. C. and 90% RH, when measured in accordance with ASTM F1249 standard, that is adapted to accommodate capsules of at least “0” size.

In still another exemplary embodiment, the intermediate aluminum layer has a thickness of 45 microns, the metallized oriented polyamide film has a thickness of 25 microns and optical density of 1.96, and the polyethylene layer has a thickness of 50 microns, wherein the laminate when cold formed into blisters, has a WVTR of 0.00021 gm/pkg/day at 37.8 deg. C. and 90% RH, when measured in accordance with ASTM F1249 standard, that is adapted to accommodate capsules of at least “0” size.

In yet another exemplary embodiment, the intermediate aluminum layer has a thickness of 45 microns, the metallized oriented polyamide film has a thickness of 25 microns and optical density of 2.2, and the polyethylene layer has a thickness of 50 microns, wherein the laminate when cold formed into blisters, has a WVTR of 0.00009 gm/pkg/day at 37.8 deg. C. and 90% RH, when measured in accordance with ASTM F1249 standard, that is adapted to accommodate capsules of at least “0” size.

In still another exemplary embodiment, the intermediate aluminum layer has a thickness of 50 microns, the metallized oriented polyamide film has a thickness of 25 microns and optical density of 1.65, and the polyethylene layer has a thickness of 50 microns, wherein the laminate when cold formed into blisters, has a WVTR of 0.00061 gm/pkg/day at 37.8 deg. C. and 90% RH, when measured in accordance with ASTM F1249 standard, that is adapted to accommodate capsules of at least “0” size.

In yet another exemplary embodiment, the intermediate aluminum layer has a thickness of 45 microns, the metallized oriented polyamide film has a thickness of 25 microns and optical density of 1.76, and the polyethylene layer has a thickness of 50 microns, wherein the laminate when cold formed into blisters, has a WVTR of 0.00054 gm/pkg/day at 37.8 deg. C. and 90% RH, when measured in accordance with ASTM F1249 standard, that is adapted to accommodate capsules of at least “0” size.

In still another exemplary embodiment, the intermediate aluminum layer has a thickness of 45 microns, the metallized oriented polyamide film has a thickness of 25 microns and optical density of 1.55, and the polyethylene layer has a thickness of 50 microns, wherein the laminate when cold formed into blisters, has a WVTR of 0.00065 gm/pkg/day at 37.8 deg. C. and 90% RH, when measured in accordance with ASTM F1249 standard, that is adapted to accommodate capsules of at least “0” size.

In yet another exemplary embodiment, the intermediate aluminum layer has a thickness of 45 microns, the metallized oriented polyamide film has a thickness of 25 microns and optical density of 1.25, and the polyethylene layer has a thickness of 50 microns, wherein the laminate when cold formed into blisters, has a WVTR of 0.00076 gm/pkg/day at 37.8 deg. C. and 90% RH, when measured in accordance with ASTM F1249 standard, that is adapted to accommodate capsules of at least “0” size.

In still another exemplary embodiment, the intermediate aluminum layer has a thickness of 45 microns, the metallized oriented polyamide film has a thickness of 25 microns and optical density of 1.96, and the polyethylene layer has a thickness of 50 microns, wherein the laminate when cold formed into blisters, has a WVTR of 0.00021 gm/pkg/day at 37.8 deg. C. and 90% RH, when measured in accordance with ASTM F1249 standard, that is adapted to accommodate capsules of at least “0” size.

The multilayer laminate of the present disclosure are used to make blister packs that can be employed for packing food products and pharmaceutical products.

The multilayer laminate of the present disclosure provides barrier against moisture, light and gas, which enhances the overall the shelf life of the product that is packaged.

In accordance with the present disclosure, the blister pack strip prepared by using the multilayer laminate of the present disclosure is small, wherein the draft angle of the blister cups is less as compared to that in the blister cups of the conventional blister pack. In other words, a relatively more number of blister cups can be formed in the multilayer laminate by using the presently disclosed multilayer laminate as compared to that in the conventional blister pack. This result in reduction in the blister pack size and also the amount of multilayer laminate needed.

The reduction in angle φ is possible because of the enhanced stretchability of the modified high density polyethylene molecules in conjunction with aluminum. This results in reduction of the blister pack volume by 35 to 56% as compared to the conventional multilayer laminates. Further, the reduction in volume leads to reduction in the amount of multilayer laminate required for fabricating the blister pack, and increases the number of blister cups.

The foregoing description of the embodiments has been provided for purposes of illustration and not intended to limit the scope of the present disclosure. Individual components of a particular embodiment are generally not limited to that particular embodiment, but, are interchangeable. Such variations are not to be regarded as a departure from the present disclosure, and all such modifications are considered to be within the scope of the present disclosure.

The present disclosure is further described in light of the following experiments which are set forth for illustration purpose only and not to be construed for limiting the scope of the disclosure. The following experiments can be scaled up to industrial/commercial scale and the results obtained can be extrapolated to industrial scale.

### EXPERIMENTAL DETAILS

In the below examples, WVTR was measured at 37.8 deg. C. and 90% RH in accordance with ASTM F1249 standard. In the examples, a laminate was prepared with in accordance with the present disclosure, details of which are given in examples 1 to 15. The laminate was then cold formed to obtain blisters. The blisters were then covered with an aluminum lid treated on its operative outer surface to prevent oxidation, and treated on its operative inner surface with coatings of heat seal lacquer to form a sealing layer. The WVTR values mentioned in examples 1-15 are for these cold formed blisters adapted to accommodate capsules of at least size “O” (zero size capsule).

### Example 1: High Barrier, PVC Free, Cold Forming, Multilayer Blister Laminate, in Accordance with the Present Disclosure [Metalized OPA/Al/PE+ Additive (Blown)]

25μ metallized oriented polyamide (OPA) film having optical density 1.25 with uniform metallization was laminated with 45μ aluminum layer and other side of aluminum layer was laminated with 50μ Polyethylene. The properties of the resulting laminated material after drying are mentioned in Table 1:

TABLE 1
properties of the resulting laminated material after drying

| Properties | Values | |
|---|---|---|
| Total thickness: | 133 | μ |
| Total grams per square meter (GSM) | 211 | |
| Tensile strength longitudinal (Kg/cm²) | 526.416 | |
| Tensile strength transverse (Kg/cm²) | 468.918 | |
| Peak elongation in % longitudinal | 15.41 | |
| Peak elongation in % transverse | 14.22 | |
| Impact strength | 1575 | gm |
| Sealing strength at 170 deg. C. C. | 0.58 | kg/cm |
| WVTR at 37.8 deg C. and 90% RH | 0.00076 | gm/pkg/day |

### Example 2: High Barrier, PVC Free, Cold Forming, Multilayer Blister Laminate, in Accordance with the Present Disclosure [Metalized OPA/Al/PE+ Additive (Blown)]

25μ metallized oriented polyamide (OPA) film having optical density 1.55 with uniform metallization was laminated with 45μ aluminum layer and other side of aluminum layer was laminated with 50μ Polyethylene. The properties of the resulting laminated material after drying are mentioned in Table 2:

TABLE 2
properties of the resulting laminated material after drying

| Properties | Values | |
|---|---|---|
| Total thickness: | 126 | μ |
| Total grams per square meter (GSM) | 203 | |
| Tensile strength longitudinal (Kg/cm²) | 632.44 | |
| Tensile strength transverse (Kg/cm²) | 609.18 | |
| Peak elongation in % longitudinal | 17.32 | |
| Peak elongation in % transverse | 16.12 | |
| Impact strength | 1580 | gm |
| Sealing strength at 170 C. | 0.52 | kg/cm |
| WVTR at 37.8 deg C. and 90% RH | 0.00065 | gm/pkg/day |

### Example 3: High Barrier, PVC Free, Cold Forming, Multilayer Blister Laminate, in Accordance with the Present Disclosure [Metalized OPA/Al/PE+ Additive (Blown)]

25μ metallized oriented polyamide (OPA) film having optical density 1.65 with uniform metallization was laminated with 45μ aluminum layer and other side of aluminum layer was laminated with 50μ Polyethylene. The properties of the resulting laminated material after drying are mentioned in Table 3:

TABLE 3
properties of the resulting laminated material after drying

| Properties | Values | |
|---|---|---|
| Total thickness: | 132 | μ |
| Total grams per square meter (GSM) | 215 | |
| Tensile strength longitudinal (Kg/cm²) | 632.44 | |
| Tensile strength transverse (Kg/cm²) | 611.28 | |
| Peak elongation in % longitudinal | 17.12 | |
| Peak elongation in % transverse | 16.30 | |
| Impact strength | 1480 | gm |
| Sealing strength at 170 C. | 0.58 | kg/cm |
| WVTR at 37.8 deg C. and 90% RH | 0.00061 | gm/pkg/day |

### Example 4: High Barrier, PVC Free, Cold Forming Multilayer Blister Laminate, in Accordance with the Present Disclosure [Metalized OPA/Al/PE+ Additive (Blown)]

25μ metallized oriented polyamide (OPA) film having optical density 1.76 with uniform metallization was laminated with 45μ aluminum layer and other side of aluminum layer was laminated with 50μ Polyethylene. The properties of the resulting laminated material after drying are mentioned in Table 4:

TABLE 4
properties of the resulting laminated material after drying

| Properties | Values | |
|---|---|---|
| Total thickness: | 134 | μ |
| Total grams per square meter (GSM) | 218 | |
| Tensile strength longitudinal (Kg/cm²) | 630.80 | |
| Tensile strength transverse (Kg/cm²) | 612.80 | |
| Peak elongation in % longitudinal | 17.32 | |
| Peak elongation in % transverse | 16.62 | |
| Impact strength | 1470 | gm |
| Sealing strength at 170 C. | 0.55 | kg/cm |
| WVTR at 37.8 deg C. and 90% RH | 0.00054 | gm/pkg/day |

### Example 5: High Barrier, PVC Free, Cold Forming Multilayer Blister Laminate, in Accordance with the Present Disclosure [Metalized OPA/Al/PE+ Additive (Blown)]

25μ metallized oriented polyamide (OPA) film having optical density 1.96 with uniform metallization was laminated with 45μ aluminum layer and other side of aluminum layer was laminated with 50μ Polyethylene. The properties of the resulting laminated material after drying are mentioned in Table 5:

TABLE 5
properties of the resulting laminated material after drying

| Properties | Values | |
|---|---|---|
| Total thickness: | 128 | μ |
| Total grams per square meter (GSM) | 211 | |
| Tensile strength longitudinal (Kg/cm²) | 610.2 | |
| Tensile strength transverse (Kg/cm²) | 597.9 | |
| Peak elongation in % longitudinal | 18.12 | |
| Peak elongation in % transverse | 17.22 | |
| Impact strength | 1475 | gm |
| Sealing strength at 170 C. | 0.59 | kg/cm |
| WVTR at 37.8 deg C. and 90% RH | 0.00021 | gm/pkg/day |

### Example 6: High Barrier, PVC Free, Cold Forming Multilayer Blister Laminate, in Accordance with the Present Disclosure [Metalized OPA/Al/PE+ Additive (Blown)]

25μ metallized oriented polyamide (OPA) film having optical density 2.2 with uniform metallization was laminated with 45μ aluminum layer and other side of aluminum layer was laminated with 50μ Polyethylene. The properties of the resulting laminated material after drying are mentioned in Table 6:

TABLE 6
properties of the resulting laminated material after drying

| Properties | Values | |
|---|---|---|
| Total thickness: | 125 | μ |
| Total grams per square meter (GSM) | 208 | |
| Tensile strength longitudinal (Kg/cm²) | 619.10 | |
| Tensile strength transverse (Kg/cm²) | 602.6 | |
| Peak elongation in % longitudinal | 18.52 | |
| Peak elongation in % transverse | 17.62 | |
| Impact strength | 1485 | gm |
| Sealing strength at 170 C. | 0.62 | kg/cm |
| WVTR at 37.8 deg C. and 90% RH | 0.00009 | gm/pkg/day |

### Example 7: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 1.25 with uniform metallization was laminated with 45μ aluminum layer and other side of aluminum layer was laminated with 50μ Polyethylene. The properties of the resulting laminated material after drying are mentioned in Table 7:

TABLE 7
properties of the resulting laminated material after drying

| Properties | Values | |
|---|---|---|
| Total thickness: | 133 | μ |
| Total grams per square meter (GSM) | 211 | |
| Tensile strength longitudinal (Kg/cm²) | 546.416 | |
| Tensile strength transverse (Kg/cm²) | 478.918 | |
| Peak elongation in % longitudinal | 16.41 | |
| Peak elongation in % transverse | 15.22 | |
| Impact strength | 1595 | gm |
| Sealing strength at 170 C. | 0.58 | kg/cm |
| WVTR at 37.8 deg C. and 90% RH | 0.00076 | gm/pkg/day |

### Example 8: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 1.55 with uniform metallization was laminated with 45μ aluminum layer and other side of aluminum layer was laminated with 50μ Polyethylene. The properties of the resulting laminated material after drying are mentioned in Table 8:

TABLE 8
properties of the resulting laminated material after drying

| Properties | Values | |
|---|---|---|
| Total thickness: | 126 | μ |
| Total grams per square meter (GSM) | 203 | |
| Tensile strength longitudinal (Kg/cm²) | 642.44 | |
| Tensile strength transverse (Kg/cm²) | 619.18 | |
| Peak elongation in % longitudinal | 17.8 | |
| Peak elongation in % transverse | 16.12 | |
| Impact strength | 1590 | gm |
| Sealing strength at 170 C. | 0.52 | kg/cm |
| WVTR at 37.8 deg C. and 90% RH | 0.00065 | gm/pkg/day |

### Example 9: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 1.65 with uniform metallization was laminated with 45μ aluminum layer and other side of aluminum layer was laminated with 50μ Polyethylene. The properties of the resulting laminated material after drying are mentioned in Table 9:

TABLE 9
properties of the resulting laminated material after drying

| Properties | Values | |
|---|---|---|
| Total thickness: | 132 | μ |
| Total grams per square meter (GSM) | 215 | |
| Tensile strength longitudinal (Kg/cm²) | 642.44 | |
| Tensile strength transverse (Kg/cm²) | 621.28 | |
| Peak elongation in % longitudinal | 17.52 | |
| Peak elongation in % transverse | 16.80 | |
| Impact strength | 1495 | gm |
| Sealing strength at 170 C. | 0.58 | kg/cm |
| WVTR at 37.8 deg C. and 90% RH | 0.00061 | gm/pkg/day |

### Example 10: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 1.76 with uniform metallization was laminated with 45μ aluminum layer and other side of aluminum layer was laminated with 50μ Polyethylene. The properties of the resulting laminated material after drying are mentioned in Table 10:

TABLE 10
properties of the resulting laminated material after drying

| Properties | Values | |
|---|---|---|
| Total thickness: | 134 | μ |
| Total grams per square meter (GSM) | 218 | |
| Tensile strength longitudinal (Kg/cm²) | 640.80 | |
| Tensile strength transverse (Kg/cm²) | 622.80 | |
| Peak elongation in % longitudinal | 18.32 | |
| Peak elongation in % transverse | 17.62 | |
| Impact strength | 1570 | gm |
| Sealing strength at 170 C. | 0.55 | kg/cm |
| WVTR at 37.8 deg C. and 90% RH | 0.00054 | gm/pkg/day |

### Example 11: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 1.96 with uniform metallization was laminated with 45μ aluminum layer and other side of aluminum layer was laminated with 50μ Polyethylene. The properties of the resulting laminated material after drying are mentioned in Table 11:

TABLE 11
properties of the resulting laminated material after drying

| Properties | Values | |
|---|---|---|
| Total thickness: | 128 | μ |
| Total grams per square meter (GSM) | 211 | |
| Tensile strength longitudinal (Kg/cm²) | 619.2 | |
| Tensile strength transverse (Kg/cm²) | 600.90 | |
| Peak elongation in % longitudinal | 19.12 | |
| Peak elongation in % transverse | 18.22 | |
| Impact strength | 1495 | gm |
| Sealing strength at 170 C. | 0.59 | kg/cm |
| WVTR at 37.8 deg C. and 90% RH | 0.00021 | gm/pkg/day |

### Example 12: High Barrier, PVC Free, Cold Forming Multilayer Blister Laminate, in Accordance with the Present Disclosure [Metalized OPA/Al/PE+ Cast]

25μ metallized oriented polyamide (OPA) film having optical density 2.2 with uniform metallization was laminated with 45μ aluminum layer and other side of aluminum layer was laminated with 50μ Polyethylene. The properties of the resulting laminated material after drying are mentioned in Table 12:

TABLE 12
properties of the resulting laminated material after drying

| Properties | Values | |
|---|---|---|
| Total thickness: | 125 | μ |
| Total grams per square meter (GSM) | 208 | |
| Tensile strength longitudinal (Kg/cm²) | 629.10 | |
| Tensile strength transverse (Kg/cm²) | 612.6 | |
| Peak elongation in % longitudinal | 19.52 | |
| Peak elongation in % transverse | 18.62 | |
| Impact strength | 1500 | gm |
| Sealing strength at 170 C. | 0.62 | kg/cm |
| WVTR at 37.8 deg. C. C. and 90% RH | 0.00009 | gm/pkg/day |

### Area Reduction Examples

### Following Chart Depicts Existing Strip Size of Strip Versus Metallized OPA/Al/PE (Bilcare Elite) Strip and its Size Reduction.

Brand details

| | | Brand | | Area |
|---|---|---|---|---|
| | | Sample - | Proposed | Reduction |
| Brand | Customer | Strip Size | Elite Size | (In %) |
| BECOSULES | PFIZER | 175 × 150 | 137 × 105 | 45 |
| ECOSPRIN | USV | 147 × 47 | 80 × 50 | 42 |
| BECOSULES-Z | PFIZER | 177 × 150 | 137 × 105 | 46 |
| AVIL | SANOFI* | 104 × 58 | 77 × 45 | 43 |
| VOVERAN | NOVARTIS | 137 × 80 | 95 × 57 | 51 |
| NEXPRO-RD | TORRENT | 96 × 155 | 105 × 70 | 51 |
| P-RD | BLUE CROSS | 125 × 150 | 116 × 113 | 30 |
| CLOPILET-A | SUN* | 85 × 144 | 105 × 70 | 40 |
| Telma | Glenmark | 115 × 97 | 96 × 81 | 30 |
| RANTAC | UNIQUE PHARM | 152 × 120 | 98.5 × 83 | 55 |
| ECOSPRIN-AV | USV | 126 × 145 | 116 × 113 | 28 |
| UNIENZYME | TORRENT | 114 × 150 | 105 × 90 | 43 |
| SUPRADYN | PIRAMAL | 164 × 102 | 126 × 78 | 41 |
| | HEALTHCARE | | | |
| OMNACORTIL | MACLEODS | 113 × 50 | 83 × 36 | 47 |
| | PHARMA | | | |
| AUGMENTIN | GLAXOSMITHKL | 100 × 175 | 112 × 70 | 55 |
| | INE* | | | |
| ACILOC | CADILA | 118 × 134 | 105 × 88 | 51 |
| | PHARMA | | | |
| BETNESOL | GLAXOSMITHKL | 89 × 66 | 64 × 52 | 43 |
| | INE* | | | |
| TEGRITAL | NOVARTIS | 132 × 49 | 111 × 56 | 4 |
| | INTL.* | | | |
| TELVAS / | ARISTO | 135 × 55 | 93 × 41 | 49 |
| AM/H/3D | PHARMA* | | | |
| GASPAZ | BIOLOGICAL E | 185 × 62 | 109 × 73 | 31 |
| R-LOC | ZYDUS CADILA* | 132 × 150 | 101 × 85 | 56 |
| R-LOC-D | ZYDUS CADILA* | 128 × 80 | 85 × 53 | 55 |
| LIMCEE 500 & | ABBOTT | 160 × 99 | 125 × 77 | 39 |
| + | | | | |
| OMEZ | DR REDDYS | 145 × 135 | 127 × 103 | 33 |
| | LABS | | | |
| BEPLEX | ANGLO FRENCH | 123 × 107 | 101 × 82 | 47 |
| FORTE | DRUGS | | | |
| CYRA-D | SYSTOPIC | 212 × 60 | 109 × 73 | 37 |
| MEGAPEN | ARISTO | 95 × 150 | 126 × 84 | 26 |
| | PHARMA* | | | |
| A TO Z NS | ALKEM | 108 × 147 | 106 × 88 | 41 |
| AMPOXIN | TORRENT | 122 × 145 | 109 × 106 | 35 |
| | PHARMA* | | | |
| CLOPITAB-A | LUPIN LIMITED | 225 × 99 | 124 × 126 | 30 |
| RABEMAC- | MACLEODS | 154 × 93 | 126 × 84 | 26 |
| DSR | PHARMA | | | |
| CELIN PLUS | KOYE | 175 × 142 | 127 × 102.5 | 48 |

It is evident from examples 1 to 14 and tables 1 to 14 that as the optical density increases, there is significant reduction in the moisture permeability i.e. there is higher barrier of package. It means lesser the value of WVTR, better the barrier of package.

### Example 15: High Barrier, PVC Free, Cold Forming Multilayer Blister Laminate, in Accordance with the Present Disclosure [Metalized OPA/Al/PE (Cast)]

25μ metallized oriented polyamide (OPA) films having optical densities varying from 0.5 to 3 with uniform metallization were prepared. Each of these films was laminated with 50μ aluminum layer and other side of aluminum layer was laminated with 40μ Polyethylene. This laminate was cold pressed to form blisters to occupy “0” size capsules which is higher in dimensions and requires higher stretching ratio to form cavity. The blisters were then covered with an aluminum lid treated on its operative outer surface to prevent oxidation, and treated on its operative inner surface with coatings of heat seal lacquer to form a sealing layer.

The properties of the resulting laminated material after drying are mentioned in Table 15:

TABLE 15
properties of the resulting laminated material after drying
Barrier against moisture vapour at 37.8 Deg. C. & 90% RH gm/package/
day for “0” size capsule cavity

| Sr. No. | Optical Density | WVTR (gm/Package/day) |
|---|---|---|
| 1 | 0.5 | 0.00095 |
| 2 | 1.25 | 0.00076 |
| 3 | 1.55 | 0.00065 |
| 4 | 1.65 | 0.00061 |
| 5 | 1.76 | 0.00054 |
| 6 | 1.96 | 0.00021 |
| 7 | 2.2 | 0.00009 |
| 8 | 2.5 | 0.000089 |
| 9 | 2.8 | 0.000087 |
| 10 | 3 | 0.000089 |

It is evident from table 15 that as the optical density increases, there is a decrease in the WVTR (water vapour transmission rate), i.e. as the optical density increases, the barrier property of the laminate increases. Thus, as the optical density increases, there is significant reduction in the moisture permeability i.e. there is higher barrier of package. It means lesser the value of WVTR, better the barrier of package.

### Technical Advancements

The present disclosure described herein above has several technical advantages including, but not limited to, the realization of high barrier PVC free cold forming blister laminate that has
reduced volume;
effectively provides water vapour barrier, thereby enhancing the shelf life of the product being packaged; and
the amount of multilayer laminate required for making the blister pack is less with high barrier against moisture, gases and light;
   and

Process for the preparation of the high barrier PVC free cold forming blister laminate is simple and environment friendly.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results. While certain embodiments of the disclosure have been described, these embodiments have been presented by way of example only, and are not intended to limit the scope of the disclosure. Variations or modifications to the formulation of this disclosure, within the scope of the invention, may occur to those skilled in the art upon reviewing the disclosure herein. Such variations or modifications are well within the spirit of this disclosure.

The numerical values given for various physical parameters, dimensions and quantities are only approximate values and it is envisaged that the values higher than the numerical value assigned to the physical parameters, dimensions and quantities fall within the scope of the disclosure unless there is a statement in the specification to the contrary.

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

1. A high barrier, polyvinyl chloride (PVC) free, cold forming multilayer blisters laminates comprising:
an intermediate aluminum layer having a thickness in the range of 20 microns to 60 microns, defining an operative outer surface and an operative inner surface;
at least one polyethylene polymer layer, selected from high density polyethylene (HDPE), medium density polyethylene, low density polyethylene, linear polyethylene, cross-linked polyethylene, and ultra-high molecular weight polyethylene (UHMWPE), having a thickness in the range of 40 microns to 80 microns, adhered to said inner surface of said intermediate layer by means of an adhesive; and
an oriented polyamide layer, metallized on its operative outer surface, said metallized oriented polyamide layer has an optical density in the range of 0.5 to 2.5,
said metallized polyamide layer having a thickness in the range of 10 microns to 60 microns, and adhered to said operative outer surface of said intermediate layer by means of said adhesive,
wherein said laminate has a water vapour transmission rate (WVTR) of less than 0.0035 gm/pkg/day.

2. The laminate as claimed in claim 1, wherein said adhesive is acrylic based adhesive.

3. The laminate as claimed in claim 2, wherein said acrylic based adhesive is selected from the group consisting of pure acrylic adhesive, and ester acrylic adhesive.

4. The laminate as claimed in claim 1, wherein a thickness of said adhesive on said intermediate layer is in the range of 3 gsm to 6 gsm.

5. The laminate as claimed in claim 1, wherein the water vapour transmission rate (WVTR) of said laminate is in the range of 0.0072 gm/pkg/day to 0.000076 gm/pkg/day.

6. The laminate as claimed in claim 1, wherein the water vapour transmission rate (WVTR) is measured for cold formed blisters adapted to accommodate a capsule of at least “0” size.

7. The laminate as claimed in claim 1, wherein said polyethylene is modified by adding linear block copolymer based on styrene and butadiene with bound styrene of 29.5% mass.

8. The laminate as claimed in claim 1, wherein said intermediate aluminum layer has a thickness of 45 microns, said metallized oriented polyamide film has a thickness of 25 microns and optical density of 1.25, and said polyethylene layer has a thickness of 50 microns, wherein said laminate when cold formed into blisters, has a WVTR of 0.00076 gm/pkg/day at 37.8 deg. C. and 90% RH, when measured in accordance with ASTM F1249 standard, that is adapted to accommodate capsules of at least “0” size.

9. The laminate as claimed in claim 1, wherein said intermediate aluminum layer has a thickness of 45 microns, said metallized oriented polyamide film has a thickness of 25 microns and optical density of 2.2, and said polyethylene layer has a thickness of 50 microns, wherein said laminate when cold formed into blisters, has a WVTR of 0.00009 gm/pkg/day at 37.8 deg. C. and 90% RH, when measured in accordance with ASTM F1249 standard, that is adapted to accommodate capsules of at least “0” size.

10. The laminate as claimed in claim 1, wherein said intermediate aluminum layer has a thickness of 45 microns, said metallized oriented polyamide film has a thickness of 25 microns and optical density of 1.55, and said polyethylene layer has a thickness of 45 microns, wherein said laminate when cold formed into blisters, has a WVTR of 0.00065 gm/pkg/day at 37.8 deg. C. and 90% RH, when measured in accordance with ASTM F1249 standard, that is adapted to accommodate capsules of at least “0” size.

11. The laminate as claimed in claim 1, wherein said intermediate aluminum layer has a thickness of 45 microns, said metallized oriented polyamide film has a thickness of 25 microns and optical density of 1.96, and said polyethylene layer has a thickness of 50 microns, wherein said laminate when cold formed into blisters, has a WVTR of 0.00021 gm/pkg/day at 37.8 deg. C. and 90% RH, when measured in accordance with ASTM F1249 standard, that is adapted to accommodate capsules of at least “0” size.

12. The laminate as claimed in claim 1, wherein said intermediate aluminum layer has a thickness of 45 microns, said metallized oriented polyamide film has a thickness of 25 microns and optical density of 2.2, and said polyethylene layer has a thickness of 50 microns, wherein said laminate when cold formed into blisters, has a WVTR of 0.00009 gm/pkg/day at 37.8 deg. C. and 90% RH, when measured in accordance with ASTM F1249 standard, that is adapted to accommodate capsules of at least “0” size.

13. The laminate as claimed in claim 1, wherein said intermediate aluminum layer has a thickness of 50 microns, said metallized oriented polyamide film has a thickness of 25 microns and optical density of 1.65, and said polyethylene layer has a thickness of 50 microns, wherein said laminate when cold formed into blisters, has a WVTR of 0.00061 gm/pkg/day at 37.8 deg. C. and 90% RH, when measured in accordance with ASTM F1249 standard, that is adapted to accommodate capsules of at least “0” size.

14. The laminate as claimed in claim 1, wherein said intermediate aluminum layer has a thickness of 45 microns, said metallized oriented polyamide film has a thickness of 25 microns and optical density of 1.76, and said polyethylene layer has a thickness of 50 microns, wherein said laminate when cold formed into blisters, has a WVTR of 0.00054 gm/pkg/day at 37.8 deg. C. and 90% RH, when measured in accordance with ASTM F1249 standard, that is adapted to accommodate capsules of at least “0” size.

15. The laminate as claimed in claim 1, wherein said intermediate aluminum layer has a thickness of 45 microns, said metallized oriented polyamide film has a thickness of 25 microns and optical density of 1.55, and said polyethylene layer has a thickness of 50 microns, wherein said laminate when cold formed into blisters, has a WVTR of 0.00065 gm/pkg/day at 37.8 deg. C. and 90% RH, when measured in accordance with ASTM F1249 standard, that is adapted to accommodate capsules of at least “0” size.

16. The laminate as claimed in claim 1, wherein said intermediate aluminum layer has a thickness of 45 microns, said metallized oriented polyamide film has a thickness of 25 microns and optical density of 1.25, and said polyethylene layer has a thickness of 50 microns, wherein said laminate when cold formed into blisters, has a WVTR of 0.00076 gm/pkg/day at 37.8 deg. C. and 90% RH, when measured in accordance with ASTM F1249 standard, that is adapted to accommodate capsules of at least “0” size.

17. The laminate as claimed in claim 1, wherein said intermediate aluminum layer has a thickness of 45 microns, said metallized oriented polyamide film has a thickness of 25 microns and optical density of 1.96, and said polyethylene layer has a thickness of 50 microns, wherein said laminate when cold formed into blisters, has a WVTR of 0.00021 gm/pkg/day at 37.8 deg. C. and 90% RH, when measured in accordance with ASTM F1249 standard, that is adapted to accommodate capsules of at least “0” size.

18. A compact blister pack comprising:
a. at least one blister shaped cup made up of a high barrier, polyvinyl chloride (PVC) free, multilayer blister laminate having:
an intermediate aluminum layer having thickness in the range of 20 microns to 60 microns, defining an operative outer surface and an operative inner surface;
at least one polyethylene polymer layer, wherein said polyethylene is at least one selected from high density polyethylene (HDPE), medium density polyethylene, low density polyethylene, linear polyethylene, cross-linked polyethylene, and ultra-high molecular weight polyethylene (UHMWPE), having thickness in the range of 40 microns to 80 microns, adhered to said inner surface of said of said intermediate layer by means of said adhesive;
an oriented polyamide layer, metallized on its operative outer surface, said metallized oriented polyamide layer has an optical density in the range of 0.5 to 2.5, said metallized oriented polyamide layer having a thickness in the range of 10 microns to 60 microns, and adhered to said operative outer surface of said intermediate layer by means of an adhesive; and
b. a lid defining an operative outer surface and an operative inner surface,
wherein said operative inner surface is coated by using a heat seal lacquer in an amount in the range of 4 gsm to 10 gsm.

19. The compact blister pack as claimed in claim 18, wherein said blister shaped cup being defined by
a first side wall having a first edge and a second edge, said first side wall extending in an operative upward direction from said lid and slanted at an angle φ with respect to a normal to said lid;
a flat wall extending from said second edge of said first side wall;
a second side wall extending from a second edge of said flat wall in an operative downward direction abutting said lid and slanted at an angle φ with respect to a normal to said lid;
a third side wall extending from a first lateral edge of said flat wall in an operative downward direction abutting said lid and slanted at an angle φ with respect to a normal to said lid; and
a fourth side wall extending from a second lateral edge of said flat wall in an operative downward direction abutting said lid and slanted at an angle φ with respect to a normal to said lid.

20. The compact blister pack as claimed in claim 19, wherein said angle φ is in the range of 15° to 25°.
